(19) United States
(12) Patent Application Publication
(10) Pub. No.: US 2023/0334097 A1
(43) Pub. Date: Oct. 19, 2023

(54) Information Retrieval System And Information Retrieval Method

(71) Applicant: Semiconductor Energy Laboratory Co., Ltd., Kanagawa-ken (JP)

(72) Inventors: Yoshitaka Dozen, Atsugi, Kanagawa (JP); Kunitaka YAMAMOTO, Atsugi, Kanagawa (JP)

(73) Assignee: Semiconductor Energy Laboratory Co., Ltd., Kanagawa-ken (JP)

(21) Appl. No.: 18/030,196

(22) PCT Filed: Sep. 28, 2021
(86) PCT No.: PCT/IB2021/058816

§ 371 Date: Apr. 4, 2023

(30) Foreign Application Priority Data
Oct. 9, 2020 (JP) 2020-171249

(51) Int. Cl. G06F 16/903

(52) U.S. Cl. CPC G06F 16/90335; G06F 2216/11

(57) ABSTRACT

An information retrieval system that is capable of retrieving a similar application and value information of the similar application for a designated application is provided. An information retrieval system is provided that receives a designated application, calculates a first degree of similarity between a specification of the designated application and each of specifications of a plurality of applications, extracts a plurality of first similar applications from the plurality of applications on the basis of the first degree of similarity, calculates a second degree of similarity between a support drawing corresponding to the scope of claims of at least one of the plurality of first similar applications and at least one drawing of the designated application, extracts at least one drawing similar to the support drawing of at least one of the plurality of first similar applications from the drawings of designated application on the basis of the second degree of similarity, and outputs value information, the support drawing, and the similar drawing for at least one of the plurality of first similar applications. Related product information or the like can be given as the value information.

### TECHNICAL FIELD

One embodiment of the present invention relates to an information retrieval system and an information retrieval method.

Note that one embodiment of the present invention is not limited to the above technical field. Examples of the technical field of one embodiment of the present invention include a semiconductor device, a display device, a light-emitting device, a power storage device, a memory device, an electronic device, a lighting device, an input device (e.g., a touch sensor), an input/output device (e.g., a touch panel), a driving method thereof, and a manufacturing method thereof.

### BACKGROUND ART

Intellectual property rights such as patents, designs, and trademarks have gained interest and awareness, and technologies to support the effective use of patents are being developed. In order to verify whether one’s patented invention is implemented by other companies, other companies’ products need to be compared with one’s patent to determine whether they infringe the patent. Frequent verification is required to ensure that one’s products are protected by its patents when existing products are improved as well as when new products are launched, for example.

Patent Document 1 discloses a system that is capable of retrieving information related to input intellectual property information. For example, the system is capable of retrieving patent documents, papers, or industrial products that are similar to a designated patent document.

### REFERENCE

### Patent Document

[Patent Document 1] Japanese Published Patent Application No. 2018-206376

### SUMMARY OF THE INVENTION

### Problems to Be Solved by the Invention

The value of inventions for which applications have been made can be measured from various perspectives. Enhancing the value (may also be called added value) of patents owned by one’s company is required after registration as well as at the stage of application. For example, the fact that the company implements the patented invention and the fact that other companies implement the patented invention are each a factor that increases the value of the patent. Even in the case where there is no record of implementation at the moment, the patent is valued high if future demand is anticipated. Note that the value of inventions for which applications have been made varies and that the present invention does not exclude values other than those given here as examples.

It is difficult to find an application infringed by other companies from among numerous applications. First, a product to be the subject of an infringement search is selected from among numerous products. Then, one’s applications are narrowed down to those that are likely to be related to the product. After that, the narrowed applications are compared one by one with the product. As described above, a lot of work is required to find a combination of a product and an application that are in the relation between infringing and being infringed.

Even if an application and a product are found to be highly related to each other, it is not easy to find out if the product is also related to another application or the application is also related to another product (e.g., a new product). Also in this case, the products and the applications need to be compared one by one.

An object of one embodiment of the present invention is to provide an information retrieval system that is capable of retrieving information with high accuracy. Another object of one embodiment of the present invention is to provide an information retrieval system that is capable of retrieving information efficiently. Another object of one embodiment of the present invention is to provide an information retrieval system that is capable of highly accurate information retrieval with a simple input method.

Another object of one embodiment of the present invention is to provide an information retrieval system that is capable of retrieving an application similar to a designated application and value information of the similar application. Another object of one embodiment of the present invention is to provide an information retrieval system that is capable of retrieving an application similar to a designated application and a product linked to the similar application.

Note that the description of these objects does not preclude the existence of other objects. One embodiment of the present invention does not need to achieve all these objects. Other objects can be derived from the description of the specification, the drawings, and the claims.

### Means for Solving the Problems

One embodiment of the present invention is an information retrieval system that includes a reception unit receiving a designated application, a processing unit performing processing using a database, and an output unit outputting information on the basis of a processing result of the processing unit. The database contains at least data of specifications, drawings, and value information of a plurality of applications. The drawings include support drawings corresponding to scopes of claims. The processing unit calculates a first degree of similarity between a specification of the designated application and each of the specifications of the plurality of applications. The processing unit extracts a plurality of first similar applications from the plurality of applications on the basis of the first degree of similarity. The processing unit calculates a second degree of similarity between the support drawing of at least one of the plurality of first similar applications and at least one drawing of the designated application. The processing unit extracts at least one drawing similar to the support drawing of at least one of the plurality of first similar applications from the drawings of the designated application on the basis of the second degree of similarity. The output unit outputs the value information, the support drawing, and the similar drawing for at least one of the plurality of first similar applications. The output unit may output the second degree of similarity between the support drawing of at least one of the plurality of first similar applications and the similar drawing.

One embodiment of the present invention is an information retrieval system that includes a reception unit receiving a designated application, a processing unit performing processing using a database, and an output unit outputting information on the basis of a processing result of the processing unit. The database contains at least data of specifications, drawings, and value information of a plurality of applications. The drawings include support drawings corresponding to scopes of claims. The processing unit calculates a first degree of similarity between a specification of the designated application and each of the specifications of the plurality of applications. The processing unit extracts a plurality of first similar applications from the plurality of applications on the basis of the first degree of similarity. The processing unit calculates a second degree of similarity between the support drawing of each of the plurality of first similar applications and at least one drawing of the designated application. The processing unit extracts at least one second similar application by performing one or both of narrowing down and rearrangement of the plurality of first similar applications on the basis of the second degree of similarity. The processing unit extracts at least one drawing similar to the support drawing of the second similar application from the drawings of the designated application on the basis of the second degree of similarity. The output unit outputs the value information, the support drawing, and the similar drawing for the second similar application. The output unit may output the second degree of similarity between the support drawing of the second similar application and the similar drawing.

The information retrieval system of one embodiment of the present invention may further include a storage unit storing the processing result.

One embodiment of the present invention is an information retrieval method including steps of receiving a designated application, calculating a first degree of similarity between a specification of the designated application and each of specifications of a plurality of applications, extracting a plurality of first similar applications from the plurality of applications on the basis of the first degree of similarity, calculating a second degree of similarity between a support drawing corresponding to a scope of claims of at least one of the plurality of first similar applications and at least one drawing of the designated application, extracting at least one drawing similar to the support drawing of at least one of the plurality of first similar applications from the drawings of the designated application on the basis of the second degree of similarity, and outputting value information, the support drawing, and the similar drawing for at least one of the plurality of first similar applications. Furthermore, the second degree of similarity between the support drawing of at least one of the plurality of first similar applications and the similar drawing may be output.

One embodiment of the present invention is an information retrieval method including steps of receiving a designated application, calculating a first degree of similarity between a specification of the designated application and each of specifications of a plurality of applications, extracting a plurality of first similar applications from the plurality of applications on the basis of the first degree of similarity, calculating a second degree of similarity between a support drawing corresponding to a scope of claims of each of the plurality of first similar applications and at least one drawing of the designated application, extracting at least one second similar application by performing one or both of narrowing down and rearrangement of the plurality of first similar applications on the basis of the second degree of similarity, extracting at least one drawing similar to the support drawing of the second similar application from the drawings of the designated application on the basis of the second degree of similarity, and outputting value information, the support drawing, and the similar drawing for the second similar application. Furthermore, the second degree of similarity between the support drawing of the second similar application and the similar drawing is output.

The value information may include related product information.

The designated application may be an application pending in the Patent Office. As the plurality of applications, at least one of an application before examination, an application under examination, and a registered application may be included.

### Effect of the Invention

According to one embodiment of the present invention, an information retrieval system that retrieves information with high accuracy can be provided. According to another embodiment of the present invention, an information retrieval system that retrieves information efficiently can be provided. According to another embodiment of the present invention, an information retrieval system that performs highly accurate information retrieval with a simple input method can be provided.

According to another embodiment of the present invention, an information retrieval system that retrieves, for a designated application, a similar application and value information of the similar application can be provided. A user can examine the value of the designated application with reference to the similar application and the value information of the similar application obtained with use of the information retrieval system. The user can also have an opportunity to make an amendment, for example, to enhance the value of the designated application.

According to another embodiment of the present invention, an information retrieval system that retrieves, for a designated application, a similar application and a product linked to the similar application can be provided.

Note that the description of these effects does not preclude the existence of other effects. One embodiment of the present invention does not need to have all these effects. Other effects can be derived from the description of the specification, the drawings, and the claims.

### BRIEF DESCRIPTION OF THE DRAWINGS

FIG. 1 is a diagram showing an example of an information retrieval system.

FIG. 2 is a diagram showing an example of an information retrieval method.

FIG. 3 is a diagram showing an example of an information retrieval method.

FIG. 4A and FIG. 4B are diagrams showing examples of information retrieval methods.

FIG. 5 is a diagram showing an example of an information retrieval method.

FIG. 6 is a diagram showing an example of an information retrieval system.

FIG. 7 is a diagram showing an example of an information retrieval system.

### MODE FOR CARRYING OUT THE INVENTION

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Therefore, the present invention should not be construed as being limited to the description in the following embodiments.

Note that in structures of the invention described below, the same portions or portions having similar functions are denoted by the same reference numerals in different drawings, and the description thereof is not repeated. Furthermore, the same hatch pattern is used for the portions having similar functions, and the portions are not especially denoted by reference numerals in some cases.

The position, size, range, or the like of each component illustrated in drawings does not represent the actual position, size, range, or the like in some cases for easy understanding. Therefore, the disclosed invention is not necessarily limited to the position, size, range, or the like disclosed in the drawings.

### Embodiment 1

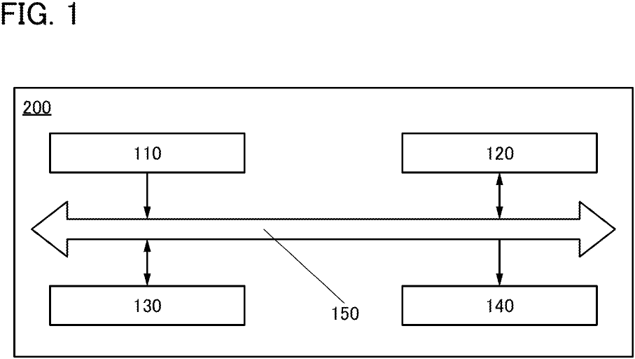

In this embodiment, an information retrieval system and information retrieval methods of embodiments of the present invention will be described with reference to FIG. 1 to FIG. 5.

The information retrieval system of one embodiment of the present invention receives a designated application and extracts a plurality of similar applications from a plurality of applications on the basis of a first degree of similarity between a specification of the designated application and a specification of each of the plurality of applications.

The similar applications are applications that are similar to the received designated application and include value information. The value information is information about the value of the similar applications. Examples of the value information include related product information, license information, related technology information, related service information, and evaluation by consultants.

In the case where applications that include value information and applications that do not include value information are mixed in a database, only the applications that include value information are extracted as the similar applications.

By designating an application, a user can retrieve applications that include value information and are similar to the designated application. Accordingly, the user can obtain information necessary for examination of the value of the designated application.

Although the case of retrieving a product related to an application is mainly described as an example in this embodiment, the information linked to the application is not limited to related product information. By using a database in which an application and at least one of the pieces of value information given above as examples are linked to each other, the information retrieval system of one embodiment of the present invention is capable of easily obtaining applications similar to the designated application and value information of the similar applications.

In the case where the similar applications include related product information, an application for which a related product is desired to be searched is designated by a user of the information retrieval system, whereby the related product information is linked and applications similar to the designated application can be retrieved. The designated application can be evaluated by referring to the similar applications to which the related product information is already linked. In addition, the scope of claims of the designated application can be amended appropriately as necessary.

However, in the case where a structure similar to the designated application and a structure related to a product are different in the similar application, the designated application is unlikely to be related to the product. It takes a lot of time and effort to confirm structures related to the product in each of a plurality of similar applications obtained by retrieval and to verify whether the structures are also described in the designated application. The same applies to another value information.

In view of the above, the information retrieval system of one embodiment of the present invention further retrieves, on the basis of a second degree of similarity between a support drawing corresponding to the scope of claims of the similar application and at least one drawing of the designated application, a drawing similar to the support drawing from the drawings of the designated application.

The support drawing corresponding to the scope of claims of the similar application shows a structure related to a product. In the case where the designated application includes a drawing similar to the support drawing of the similar application, a structure similar to the designated application and a structure related to the product in the similar application are likely to correspond to each other. Consequently, it can be said that the designated application has a high likelihood of being related to the product related to the similar application.

For the similar application, the information retrieval system of one embodiment of the present invention can output related product information, the support drawing, the similar drawing of the designated application to a terminal used by a user. This allows the user to easily identify a structure related to the product in the similar application from the support drawing. In addition, the user can easily understand from the similar drawing of the designated application whether the structure is described in the designated application. In such a manner, the user can smoothly understand which part of the designated application is related to the product. Furthermore, the user can determine how the designated application should be amended in order to increase the relevance to the product.

In addition to the above, the information retrieval system of one embodiment of the present invention may output a second degree of similarity between the support drawing and the similar drawing. The user can efficiently obtain desired information by preferentially checking the similar applications with a higher second degree of similarity.

In the above output, the similar applications can be output in descending order of first degree of similarity, for example. Alternatively, the information retrieval system of one embodiment of the present invention can narrow down and/or rearrange the similar applications on the basis of the second degree of similarity and output the similar applications. The output order of the similar applications may be determined by using the first degree of similarity and the second degree of similarity in combination. Both of a list based on the first degree of similarity (a list of similar applications) and a list based on the second degree of similarity (a list of similar drawings) may be output. Among similar applications, cases with a high probability that the designated application is related to the product related to the similar application are displayed at the top, whereby the user can efficiently obtain desired information. Specifically, a product related to the designated application can be found easily.

### <Information Retrieval System 1>

FIG. 1 is a block diagram of an information retrieval system 200. The information retrieval system 200 includes a reception unit 110, a storage unit 120, a processing unit 130, an output unit 140, and a transmission path 150.

### [Reception Unit 110]

The reception unit 110 receives a designated application. Data supplied to the reception unit 110 is supplied to one or both of the storage unit 120 and the processing unit 130 via the transmission path 150.

### [Storage Unit 120]

The storage unit 120 has a function of storing a program executed by the processing unit 130. The storage unit 120 may have a function of storing an arithmetic operation result and an inference result generated by the processing unit 130, data input to the reception unit 110, and the like.

The storage unit 120 includes at least one of a volatile memory and a nonvolatile memory. Examples of the volatile memory include a DRAM (Dynamic Random Access Memory) and an SRAM (Static Random Access Memory). Examples of the nonvolatile memory include an ReRAM (Resistive Random Access Memory, also referred to as a resistance-change memory), a PRAM (Phase change Random Access Memory), an FeRAM (Ferroelectric Random Access Memory), an MRAM (Magnetoresistive Random Access Memory, also referred to a magnetoresistive memory), and a flash memory. The storage unit 120 may include a storage media drive. Examples of the storage media drive include a hard disc drive (HDD) and a solid state drive (SSD).

The storage unit 120 may include a database containing one or both of application data and product data. For example, the storage unit 120 may include one or both of an application database and a product database.

Alternatively, the information retrieval system 200 may have a function of extracting one or both of application data and product data from an external database. For example, the information retrieval system may have a function of extracting data from one or both of an external application database and an external product database.

Alternatively, the information retrieval system 200 may have a function of extracting data from both of its own database and an external database.

The database can contain either or both of text data and image data, for example.

Instead of the database, one or both of a storage and a file server may be used. For example, in the case where a file contained in a file server is used, the database preferably contains a path for the file stored in the file server.

The case where an application database and a product database are independent of each other will be described below as an example. The present invention is not limited thereto: all data may exist together in one database, data may exist separately in three or more databases, at least part of data may exist in a storage, or at least part of data may exist in a file server.

The application database contains at least data of specifications, drawings, and related product information of a plurality of applications. The drawings include support drawings corresponding to the scope of claims (also called claims). Examples of the application include applications related to intellectual properties, such as a patent application and an application for utility model registration. In the case of a patent application, the drawings include support drawings corresponding to the scope of claims for a patent. In the case of an application for utility model registration, the drawings include support drawings corresponding to the scope of claims for utility model registration. There is no limitation on the status of each application, i.e., whether or not it is published, whether or not it is pending in the Patent Office, and whether or not it is registered. For example, the database can contain data of at least one of applications before examination, applications under examination, and registered applications or may contain all of the data.

The related product information preferably includes at least product-identifying information. Specifically, the application database preferably contains at least one of a management number (including a number for internal use) for identifying the product, a product name, a model number, and the like as the related product information.

By using product-identifying information contained in the application database, the information retrieval system of one embodiment of the present invention can extract detailed information about the product from the product database. Therefore, the application database does not necessarily contain detailed information about the product. For example, in the case where a product database already exists, the product database can be used.

The application database may also contain one or more of a manufacturer name, a release date, a product category, photograph data, and the like as the related product information.

The product database can contain one or more of a management number for identifying the product, a product name, a model number, a manufacturer name, a release date, a product category, photograph data, and the like.

The application database may also contain, for example, all of the image data of drawings of each application and data (e.g., text data or label data) indicating support drawings corresponding to the scope of claims. Alternatively, the application database may contain image data of only a support drawing corresponding to the scope of claims, of the drawings of each application.

The application database may contain meta-information about drawings. For example, information about the meaning expressed by a drawing (also called semantic information; e.g., “is a circuit diagram” and “is a memory circuit”) may be contained as the meta-information. For example, semantic information can be tagged to a drawing using artificial intelligence (AI). Alternatively, semantic information given by a person may be linked to a drawing. In that case, in addition to the degree of similarity of a support drawing or instead of the degree of similarity of a support drawing, retrieval using such meta-information may be performed. For example, in the case where the designated application includes a drawing whose meta-information is in common with that of a support drawing of an application, the application can be proposed preferentially as an application similar to the designated application.

The processing unit 130 may extract information about a support area of the scope of claims from a document and determine a support drawing on the basis of the information. Examples of the document include documents related to an application created by a person (e.g., a note in application and a note in prosecution) and documents submitted to the Patent Office (e.g., a petition, explanation of circumstances concerning accelerated examination, and written opinion). The application database may contain these documents.

The application database contains data on specifications of a plurality of applications. The specifications are stored in the form of text data, for example.

The application database may further contain data of at least one of an application management number (including a number for internal use) for identifying the application, an application family management number for identifying the application family, an application number, a publication number, a registration number, the scope of claims, drawings, an abstract, an application date, a priority date, a publication date, status, classification (e.g., patent classification and utility model classification), a category, a keyword, and the like. These pieces of information may each be used to retrieve a similar application. Alternatively, these pieces of information may each be used to identify an application when a designated application is received. Further alternatively, these pieces of information may each be output together with a processing result of the processing unit 130.

Note that the application database may contain data on applications that do not include related product information (e.g., an application for which no related products exist and an application for which the presence or absence of related products is not confirmed). For example, in the case where a designated application is selected by a user from among applications that do not include related product information, the information retrieval system is capable of executing processing using the data in the application database. This eliminates the need for the user to enter data on the specification and the drawings, resulting in easy retrieval. In addition, in the case where an application database already exists, the information retrieval system of one embodiment of the present invention is capable of executing various kinds of processing with only applications including related product information as the retrieval target by using the application database. Alternatively, processing of narrowing down to only applications including related product information may be included in a series of processing.

The product database contains data of one or more of a management number for identifying the product, a product name, a model number, a manufacturer name, a release date, a category, photograph data, and the like.

Note that data contained in the storage unit and the database can be changed as appropriate depending on value information. In the information retrieval system of one embodiment of the present invention, a database containing at least one of license information, related technology information, related service information, evaluation by consultants, and the like may be used.

### [Processing Unit 130]

The processing unit 130 has a function of performing processing such as arithmetic operation and inference using the data supplied from one or both of the reception unit 110 and the storage unit 120. The processing unit 130 also has a function of performing processing using various kinds of data contained in the database. The processing unit 130 can supply processing results such as an arithmetic operation result and an inference result to one or both of the storage unit 120 and the output unit 140.

The processing unit 130 can include an arithmetic circuit, for example. The processing unit 130 can include a central processing unit (CPU), for example.

The processing unit 130 may include a microprocessor such as a DSP (Digital Signal Processor) or a GPU (Graphics Processing Unit). The microprocessor may be constructed with a PLD (Programmable Logic Device) such as an FPGA (Field Programmable Gate Array) or an FPAA (Field Programmable Analog Array). The processing unit 130 can interpret and execute instructions from programs with the use of a processor to process various kinds of data and control programs. The programs to be executed by the processor are stored in at least one of a memory region of the processor and the storage unit 120.

The processing unit 130 may include a main memory. The main memory includes at least one of a volatile memory such as a RAM (Random Access Memory) and a nonvolatile memory such as a ROM (Read Only Memory).

For example, a DRAM, an SRAM, or the like is used as the RAM, and a virtual memory space is assigned to be used as a work space for the processing unit 130. An operating system, an application program, a program module, program data, a look-up table, and the like that are stored in the storage unit 120 are loaded into the RAM for execution. The data, program, and program module that are loaded into the RAM are each directly accessed and operated by the processing unit 130.

In the ROM, a BIOS (Basic Input/Output System), firmware, and the like for which rewriting is not needed can be stored. Examples of the ROM include a mask ROM, an OTPROM (One Time Programmable Read Only Memory), and an EPROM (Erasable Programmable Read Only Memory). Examples of the EPROM include a UV-EPROM (Ultra-Violet Erasable Programmable Read Only Memory) which can erase stored data by ultraviolet irradiation, an EEPROM (Electrically Erasable Programmable Read Only Memory), and a flash memory.

For at least part of the processing of the information retrieval system, AI is preferably used.

In particular, an artificial neural network (ANN; hereinafter just referred to as neural network) is preferably used for the information retrieval system. The neural network is obtained with a circuit (hardware) or a program (software).

In this specification and the like, a neural network refers to a general model that is modeled on a biological neural network, determines the connection strength of neurons by learning, and has the capability of solving problems. A neural network includes an input layer, intermediate layers (hidden layers), and an output layer.

In the description of the neural network in this specification and the like, to determine the connection strength of neurons (also referred to as weight coefficient) from the existing information is referred to as “learning” in some cases.

In this specification and the like, to draw a new conclusion from a neural network formed with the connection strength obtained by learning is referred to as “inference” in some cases.

### [Output Unit 140]

The output unit 140 outputs information on the basis of the processing result of the processing unit 130. For example, the output unit 140 can supply one or both of the arithmetic operation result and the inference result in the processing unit 130 to the outside of the information retrieval system 200. In addition, the output unit 140 can output various kinds of data contained in the database on the basis of the processing result of the processing unit 130.

### [Transmission Path 150]

The transmission path 150 has a function of transmitting data. Data transmission and reception among the reception unit 110, the storage unit 120, the processing unit 130, and the output unit 140 can be performed via the transmission path 150.

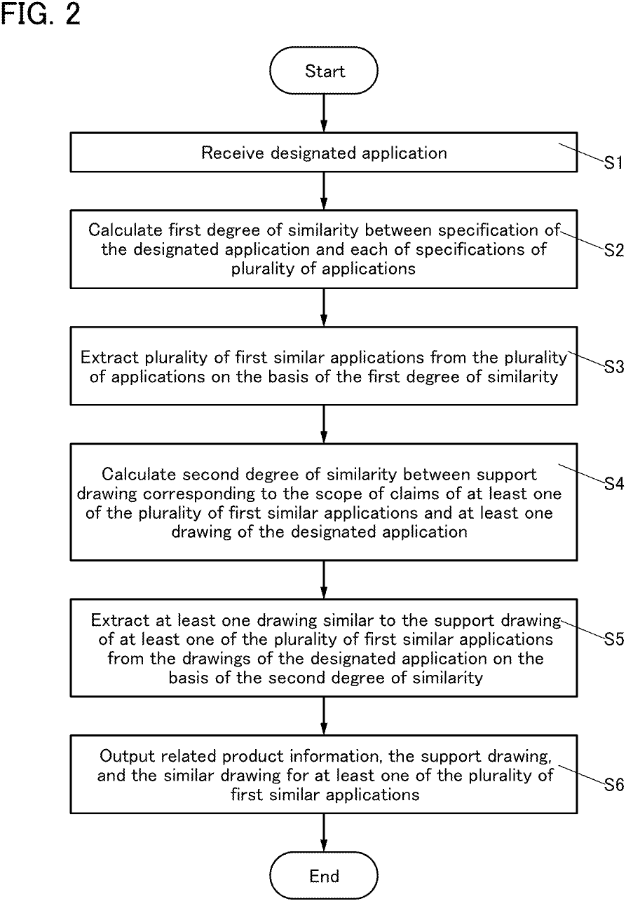

An information retrieval method of the information retrieval system of one embodiment of the present invention will be described with reference to FIG. 2 to FIG. 5. Two information retrieval methods will be described below.

### <Information Retrieval Method 1>

The information retrieval method 1 includes processing in Step S1 to Step S6 shown in FIG. 2.

### [Step S1]

In Step S1, a designated application is received. The designated application is, for example, an application for which a user wants to find a related product. There is no particular limitation on the status of the designated application. Examples of the designated application include applications that are pending in the Patent Office. The designated application may be, for example, any of an application before examination, an application under examination, and a registered application.

The user can directly input text data of specification and image data of drawings of the designated application.

In the case where the designated application is contained in a database or the like, the user can designate an application for which the user wants to retrieve information by inputting application-identifying information. The user may input application family-identifying information in some cases. The information retrieval system extracts data on the designated application (specifically, data required for the subsequent processing) from an application database or the like on the basis of the information input by the user.

Examples of the application- (application family-) identifying information include an application management number, an application family management number, an application number, a publication number, and a registration number.

### [Step S2]

In Step S2, a first degree of similarity between a specification of the designated application and a specification of each of a plurality of applications is calculated.

Here, the data of the plurality of applications is contained in the database or the like as described above and includes at least data of specifications, drawings, and value information (here, related product information). The drawings include support drawings corresponding to the scope of claims.

In the case where data of applications that do not include related product information is contained in the database, the first degree of similarity may be calculated only for applications that include related product information in Step S2. Alternatively, a step of narrowing down to applications that include related product information may be performed in Step S3.

The degree of similarity between two specifications can be obtained by vectorizing (digitizing) the specifications (text) and calculating one or both of the degree of similarity and distance between the vectors. In other words, one or both of the degree of similarity and distance between the vectors can be regarded as the first degree of similarity.

The appearance frequencies of words included in the specification may be obtained and a word ranking in descending order of appearance frequency may be created. In that case, the degree of similarity of the word ranking between two specifications can be regarded as the first degree of similarity.

The degree of agreement between two specifications may be scored using words included in the specifications and their synonyms, and the resulting score may be regarded as the first degree of similarity.

A method for calculating the first degree of similarity can be determined as appropriate depending on the language of the specification. The information retrieval system of one embodiment of the present invention can retrieve an application in at least one of the following languages, for example: Japanese, English, German, French, Chinese, and Korean.

In the case of a language like Japanese that is written without any space between words, morphological analysis is preferably performed to divide text into words. In the case where the degree of similarity is calculated by extracting only a specific part of speech, for example, morphological analysis is preferably performed regardless of language.

Specifically, one or more of morphological analysis, syntactic analysis, semantic analysis, and contextual analysis can be performed on text data of the specification. In the morphological analysis, text written in a natural language is divided into morphemes (smallest meaningful units in a language), and the part of speech of the morphemes can be determined, for example. This allows only nouns to be extracted from each specification, for example.

For example, Mecab, which is a morphological analysis engine, can be used to perform morphological analysis. For example, CaboCha, which is a dependency analysis tool, can be used to perform syntactic analysis (dependency analysis).

Word segmentation (separating words with spaces), N-gram (also called N-character index method, an N-gram method, and the like), and the like may be used to perform one or both of text division and string (word) extraction on the text data of the specification.

A variety of methods are given as a method for vectorizing text.

Examples of the method for vectorizing text according to the number of times words appear include TF-IDF (Term Frequency-Inverse Document Frequency). A TF value represents the appearance frequency of each word in a specification, and an IDF value represents the concentration degree of a word in some specifications. As the number of times that a word appears in one specification increases, the TF value of the word in the specification increases. The IDF value of a word that appears in many specifications is small, and the IDF value of a word that appears only in a few specifications is large. Calculating the product of the TF value and the IDF value of each word can provide a score indicating whether the word characterizes the specification.

Distributed representation of words may be used to vectorize text. The distributed representation of words is also called word embedding. A distributed representation vector of a word is a vector that represents a word as a series of values quantified with respect to the feature elements (dimensions). Vectors of words with similar meanings are close to each other. For example, the distributed representation vector of a word can be generated by machine learning, e.g., a neural network.

Here, an example of a method for generating a distributed representation vector of a word using a neural network is described. Learning of the neural network is conducted with supervised learning. Specifically, one word is given to an input layer, and surrounding words of the word are given to an output layer, thereby having the neural network learn the probability of the surrounding words to the word. A middle layer (hidden layer) preferably includes relatively low-dimensional vectors whose dimension number is greater than or equal to 10 and less than or equal to 1000. The vector after learning is the distributed representation vector of the word.

The distributed representation of the word can be created using an opened-sourced algorithm Word2vec, for example. Word2vec allows words to be vectorized considering features and semantic structures of the words, on the assumption that words used in the same context have the same meaning.

In vectorization of the words, the distributed representation vector of the word is generated, whereby it is possible to calculate the degree of similarity and the distance between the words with calculation of the vectors. When the degree of similarity between two vectors is high, the two vectors can be regarded as being highly related. When the distance between two vectors is small, the two vectors can be regarded as being highly related.

The degree of similarity between two vectors is calculated using cosine similarity, the covariance, the unbiased covariance, the Pearson product-moment correlation coefficient, or the like. Among them, cosine similarity is particularly preferably used.

The distance between two vectors is calculated using Euclidean distance, standard (standardized, average) Euclidean distance, Mahalanobis distance, Manhattan distance, Chebyshev distance, Minkowski distance, or the like.

A word may be represented by a vector using another method. For example, a word can be vectorized using one-hot representation (also called one hot vector). A word in a specification may be represented by a vector of the number of times the word appears with use of Bag-of-Words using the one-hot representation.

Whereas one dimension is assigned to one word in the one-hot representation, words can be represented by low-dimensional real-valued vectors in the distributed representation, which enables the words to be represented with a small number of dimensions even when the volume of vocabulary is increased. Thus, the amount of calculation is unlikely to increase even when the number of words included in a corpus is large, and an enormous quantity of data can be processed in a short time.

Doc2Vec, Sent2Vec, and the like, which are methods using distributed representation of text, may be used.

As described above, a variety of methods are given as the calculation method of the first degree of similarity, and the calculation method is not particularly limited.

### [Step S3]

In Step S3, a plurality of first similar applications are extracted from the plurality of applications on the basis of the first degree of similarity.

For example, an application with a first degree of similarity higher than or equal to a reference value or an application with a first degree of similarity higher than the reference value can be extracted as the first similar application. When the first degree of similarity is expressed as a value higher than or equal to 0 and less than or equal to 1, the reference value can be, for example, 0.70, 0.75, 0.80, 0.85, or 0.90. Note that the reference value can be determined as appropriate and may be less than 0.70.

Alternatively, for example, a predetermined number of applications with high first degrees of similarity can be extracted. For example, the top 100, 200, 300, 400, or 500 applications with high first degrees of similarity may be extracted. Alternatively, the top applications with high first degrees of similarity in a number equivalent to 10 %, 20 %, 30 %, 40 %, or 50 % of the plurality of applications may be extracted.

In the case where the applications contained in the database are narrowed down to applications that include related product information in Step S3, the applications may be narrowed down before a predetermined number of applications are extracted or after a predetermined number of applications are extracted. For example, in the case where the applications are narrowed down before 100 applications, which is a predetermined number of applications, are extracted, the 100 applications are extracted; in the case where the applications are narrowed down after a predetermined number of applications are extracted, less than or equal to 100 applications are extracted.

Alternatively, for example, a predetermined number or less of applications with first degrees of similarity higher than or equal to a reference value or a predetermined number or less of applications with first degrees of similarity higher than the reference value can be extracted. Specifically, in the case where 300 applications have first degrees of similarity higher than or equal to 0.70 and the predetermined number is 250, the top 250 applications with high first degrees of similarity are extracted as the first similar applications. In addition, in the case where 200 applications have first degrees of similarity higher than or equal to 0.70 and the predetermined number is 250, the 200 applications with the first degrees of similarity higher than or equal to 0.70 are extracted as the first similar applications.

The plurality of applications are narrowed down to the applications used in the subsequent processing (the first similar applications) in Step S3, whereby the processing amount and processing time in the subsequent steps can be reduced.

Narrowing down applications using the first degree of similarity enables more detailed retrieval of applications having a close similarity to the designated application. Thus, information can be retrieved efficiently and accurately.

By listing and outputting the plurality of applications on the basis of the first degree of similarity, the applications that have a close similarity to the designated application can be displayed at the top, which allows a user to find a desired application more easily from the retrieval result and work efficiency to be improved.

Note that at this stage, information about the first similar applications may be generated as a first list on the basis of the first degree of similarity and the first list may be output. In the first list, the first similar applications are preferably listed in descending order of first degree of similarity. For example, in the case where processing is performed in the next step with use of information input by a user, the first list is preferably generated and output before Step S4. In that case, there is no particular limitation on the information to be output and a number with which the first similar application can be identified (e.g., an application management number, an application number, a publication number, and a registration number) and the first degree of similarity may be output together, for example.

Note that although the example in which the first similar applications are extracted in Step S3 is described in this embodiment, the present invention is not limited thereto. The processing may skip Step S3 and proceed to Step S4. For example, in the case where the number of applications for which the first degree of similarity is obtained is small, narrowing down of the applications is not necessarily performed. The subsequent processing may be performed with all applications as the first similar applications. In that case, the first degree of similarity can be used, for example, to determine the order in which the applications are output before Step S4 and/or in Step S6. For example, the processing results of the applications can be output in descending order of first degree of similarity.

### [Step S4]

In Step S4, a second degree of similarity between a support drawing corresponding to the scope of claims of at least one of the plurality of first similar applications and at least one drawing of the designated application is calculated.

The first similar applications have a high degree of similarity to the designated application; however, a structure similar to the designated application and a structure related to a product might differ from each other. The support drawing corresponding to the scope of claims of the first similar application shows a structure related to a product. In the case where the designated application has a drawing similar to the support drawing (i.e., a drawing with a high second degree of similarity), it can be said that the structure similar to the designated application and the structure related to the product are likely to correspond to each other. In other words, the designated application is likely to be related to the product. By checking the drawings with a high second degree of similarity, the relation between the designated application, the first similar applications, and the related product can be understood efficiently. In addition, the product related to the designated application can be found quickly.

In Step S4, the second degree of similarity can be calculated for all of the plurality of first similar applications. The second degree of similarity may be calculated for at least one of the plurality of first similar applications that is designated by a user. The second degree of similarity may be calculated for only a predetermined number of top applications with high first degrees of similarity out of the plurality of first similar applications. The second degree of similarity may be calculated for the first similar applications until the number of applications with a second degree of similarity higher than a reference value reaches the predetermined number. In that case, the processing is preferably performed in descending order of first degree of similarity.

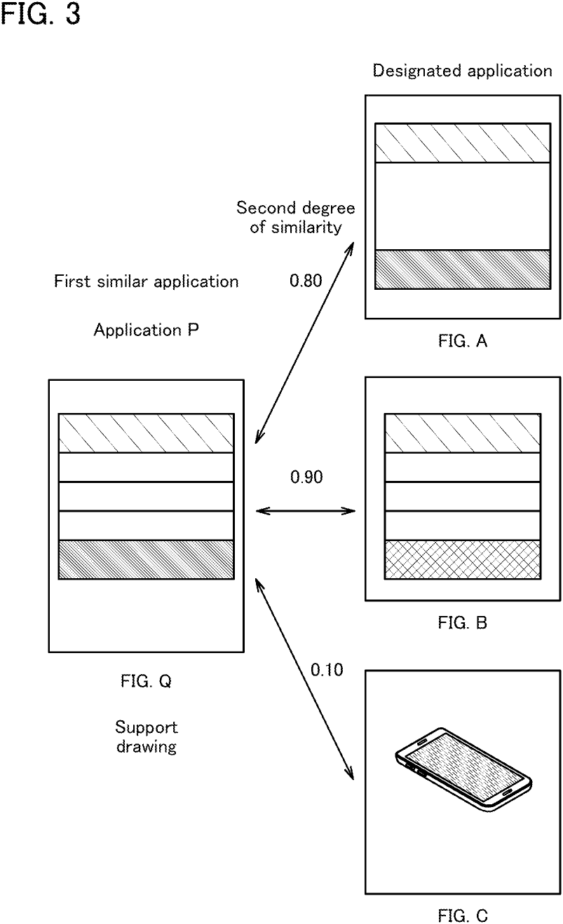

FIG. 3 shows a conceptual diagram of calculation of the second degree of similarity. For example, in the case where a support drawing of Application P that is a first similar application is FIG. Q, a second degree of similarity between FIG. Q and each drawing of a designated application is calculated. FIG. 3 shows an example in which the designated application has three drawings: FIG. A, FIG. B, and FIG. C. In the example shown in FIG. 3, the second degree of similarity between FIG. Q and FIG. A is 0.80, the second degree of similarity between FIG. Q and FIG. B is 0.90, and the second degree of similarity between FIG. Q and FIG. C is 0.10. Note that these values are not actual calculation results.

The degree of similarity between two images is preferably calculated using a convolutional neural network (CNN). In particular, deep learning with the CNN is preferably used.

One or more of blurring (also called leveling or smoothing) processing, inversion processing, change (decrease) of resolution, and binarization can be performed on the data of the drawings.

When data in different image formats are dealt with, channel transformation is preferably performed to equalize the number of channels of the data. For example, the jpg format has three channels: R, G, and B (red, green, and blue). Meanwhile, the png format has transparency information (alpha channel) in addition to R, G, and B. Therefore, it is preferable that the number of channels be equalized and the dimensions of data be unified when both the jpg format and the png format are dealt with, for example.

For example, the second degree of similarity can be calculated by obtaining how much the values of coordinates of two drawings match. For example, cosine similarity can be used as the second degree of similarity.

Specifically, by various kinds of image processing, a drawing can be processed to consist of 64 coordinates in 8 rows and 8 columns, and image data at each coordinate can be processed so as to have a value of 0 (black) or 1 (white) by binarization. Then, a calculation result of cosine similarity using the data (here, 64-dimensional data) can be used as the second degree of similarity.

In the case where similar descriptions in the designated application and the similar application correspond to one technical feature of each application and drawings supporting the descriptions in the designated application and the similar application express similar meanings, there is a high probability of infringement on the same product. Even if the cosine similarity between two drawings is low due to different drawers or other reasons, the drawings might express similar meanings.

Therefore, the second degree of similarity between the support drawing and at least one drawing of the designated application may be calculated using information about the meaning expressed by the drawing (also called semantic information). For example, scoring may be performed such that a drawing with the same semantic information has a higher second degree of similarity than a drawing with different semantic information. The second degree of similarity may be calculated using only semantic information or may be calculated in combination with cosign similarity or the like.

A variety of methods are given as the calculation method of the second degree of similarity and the calculation method is not particularly limited.

In Step S4, the first similar applications that have been narrowed down in Step S3 are processed, whereby the processing amount and processing time can be reduced. In addition, in Step S4, all of the first similar applications are not necessarily processed and a necessary number of first similar applications can be processed on the basis of one or both of the first degree of similarity and designation by a user.

### [Step S5]

In Step S5, at least one drawing similar to the support drawing of at least one of the plurality of first similar applications is extracted from the drawings of the designated application on the basis of the second degree of similarity.

For example, a second list may be generated in which the drawings of the designated application are arranged in descending order of second degree of similarity for each first similar application. In that case, all of the drawings of the designated application may be rearranged without extraction of the similar drawing.

For example, a drawing with a second degree of similarity higher than or equal to a reference value or a drawing with a second degree of similarity higher than the reference value can be extracted as a drawing similar to the support drawing. When the second degree of similarity is expressed as a value higher than or equal to 0 and less than or equal to 1, the reference value can be, for example, 0.70, 0.75, 0.80, 0.85, or 0.90. Note that the reference value can be determined as appropriate and may be less than 0.70.

In the case where the reference value is set for the second degree of similarity, there might be an application in the first similar applications whose support drawing is judged not to be similar to any of the drawings of the designated application. Although such an application has a high degree of similarity to the designated application, it can be said that a structure similar to the designated application and a structure similar to a product are likely to differ from each other. Therefore, in Step S5, a drawing similar to the support drawing of not all of the first similar applications but at least one of the first similar applications may be extracted from the drawings of the designated application.

Alternatively, for example, a predetermined number of drawings with high second degrees of similarity can be extracted. For example, the top one, two, three, four, or five drawings with high second degrees of similarity may be extracted. Alternatively, the top drawings with high second degrees of similarity in a number equivalent to 10 %, 20 %, 30 %, 40 %, or 50 % of the drawings of the designated application may be extracted.

Further alternatively, for example, a predetermined number or less of drawings with second degrees of similarity higher than or equal to a reference value or a predetermined number or less of applications with second degrees of similarity higher than the reference value can be extracted. Specifically, in the case where three drawings have second degrees of similarity higher than or equal to 0.70 and the predetermined number is two, the top two drawings with high second degrees of similarity are extracted as drawings similar to the support drawing. In addition, in the case where one drawing has a second degree of similarity higher than or equal to 0.70 and the predetermined number is two, the one drawing with the second degree of similarity higher than or equal to 0.70 is extracted as a drawing similar to the support drawing.

Narrowing down the drawings using the second degree of similarity allows easy comparison between the support drawing of the first similar application and the drawing of the designated application similar to the support drawing. As a result, the relation between the designated application, the first similar application, and the related product can be understood efficiently. In addition, a product related to the designated application can be found. Furthermore, amendment of the scope of claims may be considered depending on the situation so that the designated application can cover the product.

### [Step S6]

In Step S6, the related product information, the support drawing, and the similar drawing are output for at least one of the plurality of first similar applications.

Furthermore, another piece of information can also be output. For example, information can be output from one or both of the application database and the product database. For example, at least one of various kinds of information (e.g., an application management number, an application date, status, and a keyword) related to the first similar application can be output. In addition, one or both of the first degree of similarity and the second degree of similarity, which have been calculated in the previous steps, can be output.

The output layout (display layout) may be determined as appropriate depending on, for example, the information to be output and the amount thereof. For example, data may be output separately for a screen where a user checks the list of similar applications and a screen where the user compares the support drawing and the similar drawings.

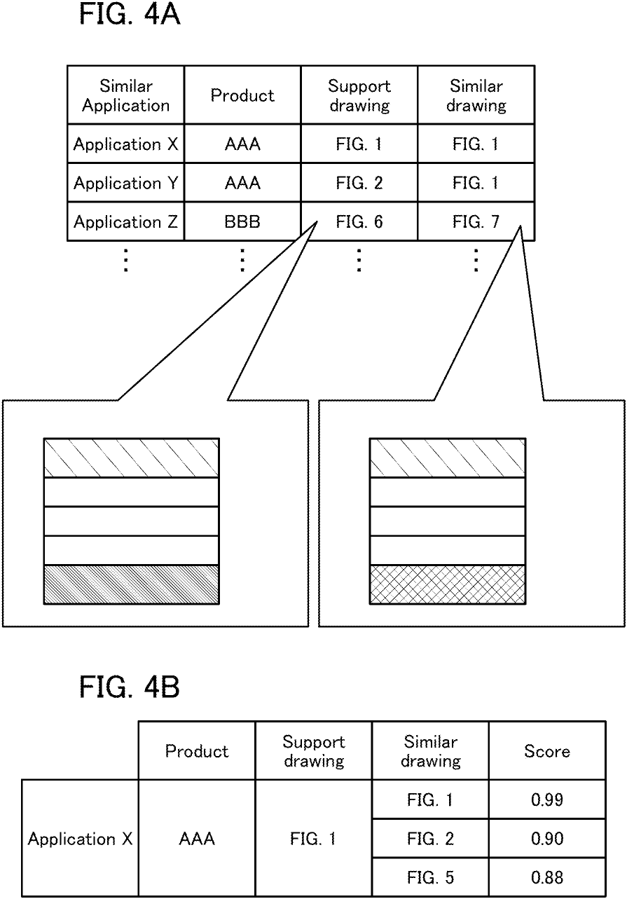

FIG. 4A shows an example of output. As the first similar applications, Application X, Application Y, and Application Z are output in this order. For example, the first similar applications are output in descending order of first degree of similarity, in descending order of second degree of similarity, or in descending order of overall first degree of similarity and second degree of similarity.

In addition, information about a product related to each of the first similar applications is output. Application X and Application Y are both related to Product AAA, and Application Z is related to Product BBB.

In addition, support drawings of the first similar applications are output. For example, both the drawing number and the drawing are preferably output. A link to the drawing may be displayed so that the drawing can be checked on another screen.

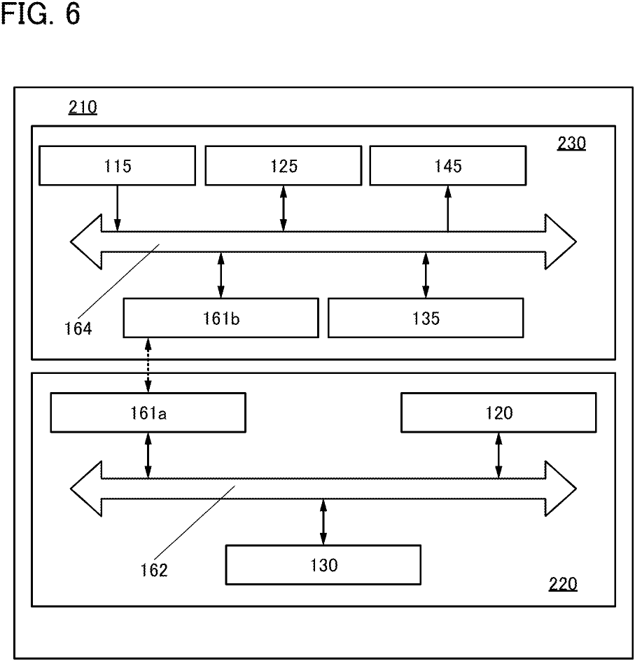

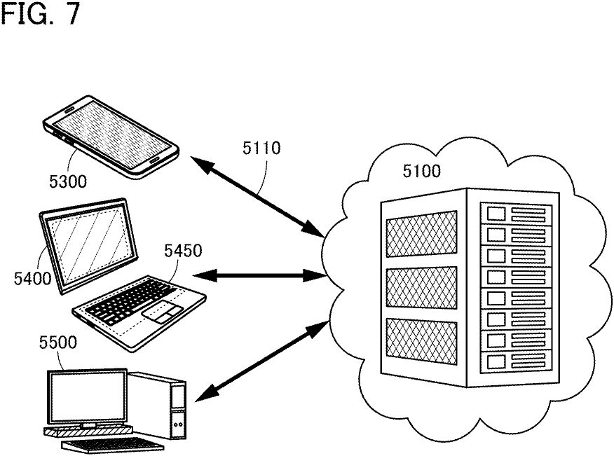

A support drawing of Application X is FIG. 1 and a similar drawing in the designated application is FIG. 1. A support drawing of Application Y is FIG. 2 and a similar drawing in the designated application is FIG. 1. A support drawing of Application Z is FIG. 6 and a similar drawing in the designated application is FIG. 7.

FIG. 4A shows an example in which drawings similar to the support drawing are extracted one by one from the drawings of the designated application on the basis of the second degree of similarity and output. As shown in FIG. 4B, a plurality of similar drawings may be extracted and the second degrees of similarity (scores) may also be output.

Note that although the example in which the similar drawing is extracted in Step S5 is described in this embodiment, the present invention is not limited thereto. The processing may skip Step S5 and proceed to Step S6. In that case, in Step S6, the related product information and the support drawing can be output for at least one of the plurality of first similar applications, and furthermore the second degrees of similarity to the support drawing can be output for all of the drawings of the designated application. Alternatively, information can be output on the basis of the second list created in Step S5. In Step S6, both the first list and the second list may be output.

As described above, the information retrieval method of this embodiment makes it possible to retrieve the application that is similar to the designated application and includes related product information. By calculating the degree of similarity between the support drawing of the similar application and each drawing of the designated application, a similar application in which a structure similar to the designated application and a structure related to a product are likely to correspond to each other can be retrieved. As a result, of the products related to the similar application, a product that is also likely to be related to the designated application can be found efficiently.

### <Information Retrieval Method 2>

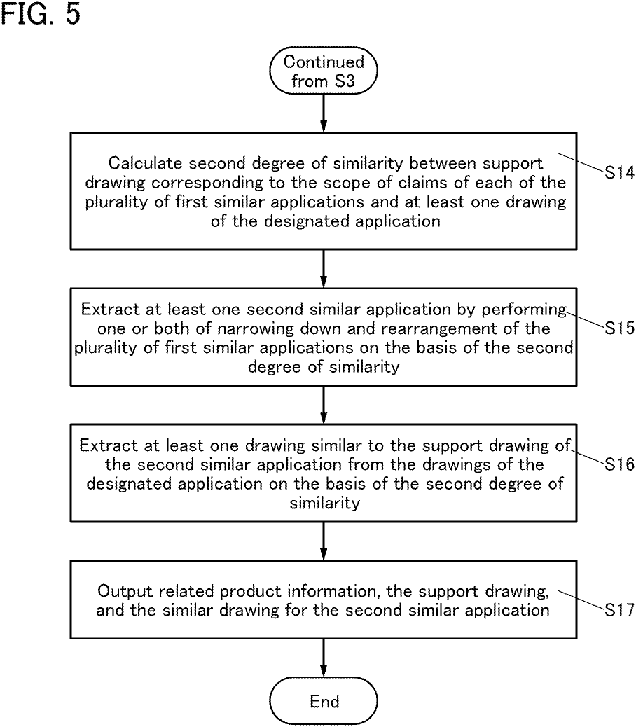

The information retrieval method 2 includes processing in Step S1 to Step S3 shown in FIG. 2 and processing in Step S14 to Step S17 shown in FIG. 5.

The processing in Step S 1 to Step S3 are the same as that in <Information retrieval method 1> and thus are not described.

### [Step S14]

In Step S14, a second degree of similarity between a support drawing corresponding to the scope of claims of each of the plurality of first similar applications and at least one drawing of the designated application is calculated.

In Step S14, the second degree of similarity is preferably calculated for all of the plurality of first similar applications. Otherwise, the processing can be performed in the same manner as Step S4.

### [Step S15]

In Step S15, one or both of narrowing down and rearrangement of the plurality of first similar applications are performed on the basis of the second degree of similarity, whereby at least one second similar application is extracted.

When a final processing result is output with the plurality of first similar applications arranged on the basis of the first degree of similarity, an application, of the first similar applications, in which a structure similar to the designated application and a structure related to the product differ from each other might be displayed at the top.

By narrowing down the similar applications on the basis of the second degree of similarity, an application in which a structure similar to the designated application and a structure related to the product are likely to correspond to each other can be displayed at the top. For example, of the first similar applications, an application that includes a support drawing whose second degree of similarity to any of the drawings of the designated application is higher than or equal to a reference value can be extracted as the second similar application.

By rearranging the similar applications on the basis of the second degree of similarity, an application in which a structure similar to the designated application and a structure related to the product are likely to correspond to each other can be displayed at the top. Alternatively, the similar applications may be rearranged on the basis of both the first degree of similarity and the second degree of similarity. Note that in the case where only rearrangement of similar applications is performed, for example, the number of first similar applications and the number of second similar applications may be the same. In other words, Step S15 may be rephrased as a step of rearranging the plurality of first similar applications on the basis of the second degree of similarity.

As described above, the use of the second degree of similarity enables a similar application linked to a product that is likely to be related to the designated application to be displayed at the top of retrieval results.

### [Step S16]

In Step S16, at least one drawing similar to the support drawing of the second similar application is extracted from the drawings of the designated application on the basis of the second degree of similarity.

Step S16 can be performed in the same manner as Step S5 except that the object is the second similar application. In some cases, Step S15 and Step S16 are performed at the same time or the processing of Step S15 and the processing of Step S16 are difficult to distinguish.

### [Step S17]

In Step S17, for the second similar application, the related product information, the support drawing, and the similar drawing are output.

Step S17 can be performed in the same manner as Step S6 except that the object is the second similar application.

As described above, the information retrieval system of this embodiment makes it possible to retrieve the application similar to the designated application and value information of the product related to the similar application, or the like. By performing retrieval using the degree of similarity between the support drawing corresponding to the scope of claims of the similar application and the drawing of the designated application as well as the degree of similarity between specifications of the designated application and the similar application, cases, among the similar applications, in which a structure similar to the designated application and a structure related to the value information are likely to correspond to each other can be presented to a user. This makes it possible to provide useful information and assistance for the user to examine the value of the designated application. For example, the user can easily find a product related to the designated application.

This embodiment can be combined with the other embodiments as appropriate. In the case where a plurality of structure examples are described in one embodiment in this specification, the structure examples can be combined as appropriate.

### Embodiment 2

In this embodiment, an information retrieval system of one embodiment of the present invention will be described with reference to FIG. 6 and FIG. 7.

### <Information Retrieval System 2>

FIG. 6 is a block diagram of an information retrieval system 210. The information retrieval system 210 includes a server 220 and a terminal 230 (e.g., a personal computer). Note that the description of <Information retrieval system 1> in Embodiment 1 can be referred to for the same components as those in the information retrieval system 200 shown in FIG. 1.

The server 220 includes a communication unit 161a, a transmission path 162, the storage unit 120, and the processing unit 130. Although not shown in FIG. 6, the server 220 may further include at least one of a reception unit, a database, an output unit, an input unit, and the like.

The terminal 230 includes a communication unit 161b, a transmission path 164, an input unit 115, a storage unit 125, a processing unit 135, and a display unit 145. Examples of the terminal 230 include a tablet personal computer, a laptop personal computer, and various portable information terminals. The terminal 230 may be a desktop personal computer without the display unit 145 and may be connected to a monitor functioning as the display unit 145, or the like.

A user of the information retrieval system 210 inputs information about a designated application from the input unit 115 in the terminal 230 to the server 220. The information is transmitted from the communication unit 161b to the communication unit 161a.

For example, text data of specification and image data of drawings of the designated application are transmitted from the communication unit 161b to the communication unit 161a. In addition, for example, application-identifying information is transmitted from the communication unit 161b to the communication unit 161a.

The information received by the communication unit 161a is stored in a memory included in the processing unit 130 or the storage unit 120 via the transmission path 162. The information may be supplied from the communication unit 161a to the processing unit 130 via a reception unit (see the reception unit 110 shown in FIG. 1).

Various kinds of processing described in <Information retrieval method 1> and <Information retrieval method 2> in Embodiment 1 are performed in the processing unit 130. These kinds of processing require high processing capacity, and thus are preferably performed in the processing unit 130 included in the server 220. The processing unit 130 preferably has higher processing capacity than the processing unit 135.

A processing result of the processing unit 130 is stored in the memory included in the processing unit 130 or the storage unit 120 via the transmission path 162. After that, the processing result is output from the server 220 to the display unit 145 in the terminal 230. The processing result is transmitted from the communication unit 161a to the communication unit 161b. On the basis of the processing result of the processing unit 130, various kinds of data contained in a database may be transmitted from the communication unit 161a to the communication unit 161b. The processing result may be supplied from the processing unit 130 to the communication unit 161a via an output unit (the output unit 140 shown in FIG. 1).

### [Communication Unit 161a and Communication Unit 161b]

The server 220 and the terminal 230 can transmit and receive data with the use of the communication unit 161a and the communication unit 161b. As the communication unit 161a and the communication unit 161b, a hub, a router, a modem, or the like can be used. Data may be transmitted or received through wire communication or wireless communication (e.g., radio waves or infrared rays).

### [Transmission Path 162 and Transmission Path 164]

The transmission path 162 and the transmission path 164 have a function of transmitting data. The communication unit 161a, the storage unit 120, and the processing unit 130 can transmit and receive data via the transmission path 162. The input unit 161b, the input unit 115, the memory unit 125, the processing unit 135, and the display unit 145 can transmit and receive data via the transmission path 164.

### [Input Unit 115]

The input unit 115 can be used when a user designates an application. For example, the input unit 115 can have a function of operating the terminal 230; specific examples thereof include a mouse, a keyboard, and a touch panel.

### [Storage Unit 125]

The storage unit 125 may store one or both of the data on the designated application and the data supplied from the server 220. The memory unit 125 may include at least part of the data that can be included in the memory unit 120.

### [Processing Unit 130 and Processing Unit 135]

The processing unit 135 has a function of performing arithmetic operation or the like with use of data supplied from the communication unit 161b, the storage unit 125, the input unit 115, or the like. The processing unit 135 may have a function of performing at least part of processing that can be performed by the processing unit 130.

Each of the processing unit 130 and the processing unit 135 can include one or both of a transistor including a metal oxide in its channel formation region (OS transistor) and a transistor including silicon in its channel formation region (Si transistor).

In this specification and the like, a transistor including an oxide semiconductor or a metal oxide in a channel formation region is referred to as an oxide semiconductor transistor or an OS transistor. A channel formation region of an OS transistor preferably includes a metal oxide.

In this specification and the like, a metal oxide is an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases. That is to say, in the case where a metal oxide has at least one of an amplifying function, a rectifying function, and a switching function, the metal oxide can be referred to as a metal oxide semiconductor, or OS for short.

The metal oxide included in the channel formation region preferably contains indium (In). When the metal oxide included in the channel formation region is a metal oxide containing indium, the carrier mobility (electron mobility) of the OS transistor is high. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The semiconductor layer may be a metal oxide that does not contain indium and contains zinc, a metal oxide that does not contain indium and contains gallium, a metal oxide that does not contain indium and contains tin, or the like, e.g., zinc tin oxide or gallium tin oxide.

The processing unit 130 preferably includes an OS transistor. The OS transistor has an extremely low off-state current; therefore, with use of the OS transistor as a switch for retaining electric charge (data) that has flowed into a capacitor functioning as a memory element, a long data retention period can be ensured. When at least one of a register and a cache memory included in the processing unit 130 has such a feature, the processing unit 130 can be operated only when needed, and otherwise can be off while data processed immediately before turning off the processing unit 130 is stored in the memory element. In other words, normally-off computing is possible and the power consumption of the information retrieval system can be reduced.

### [Display Unit 145]

The display unit 145 has a function of displaying an output result. Examples of the display unit 145 include a liquid crystal display device and a light-emitting display device. Examples of light-emitting elements that can be used in the light-emitting display device include an LED (Light Emitting Diode), an OLED (Organic LED), a QLED (Quantum-dot LED), and a semiconductor laser. It is also possible to use, as the display unit 145, a display device using a MEMS (Micro Electro Mechanical Systems) shutter element, an optical interference type MEMS element, or a display device using a display element employing a microcapsule method, an electrophoretic method, an electrowetting method, an Electronic Liquid Powder (registered trademark) method, or the like, for example.

### FIG. 7 Is a Conceptual Diagram of the Information Retrieval System of This Embodiment.

The information retrieval system shown in FIG. 7 includes a server 5100 and terminals (also referred to as electronic devices). Communication between the server 5100 and each terminal is conducted via an Internet connection 5110.

The server 5100 is capable of performing arithmetic operation using data input from the terminal via the Internet connection 5110. The server 5100 is capable of transmitting an arithmetic operation result to the terminal via the Internet connection 5110. Accordingly, the burden of arithmetic operation on the terminal can be reduced.

In FIG. 7, an information terminal 5300, an information terminal 5400, and an information terminal 5500 are shown as the terminals. The information terminal 5300 is an example of a portable information terminal such as a smartphone. The information terminal 5400 is an example of a tablet terminal. When the information terminal 5400 is connected to a housing 5450 with a keyboard, the information terminal 5400 can be used as a notebook information terminal. The information terminal 5500 is an example of a desktop information terminal.

With such a structure, a user can access the server 5100 from the information terminal 5300, the information terminal 5400, the information terminal 5500, and the like. Then, through the communication via the Internet connection 5110, the user can receive a service offered by an administrator of the server 5100. Examples of the service include a service with use of the information retrieval method of one embodiment of the present invention. In the service, an artificial intelligence may be utilized in the server 5100.

This embodiment can be combined with the other embodiments as appropriate.

Reference Numerals

| | |
|---|---|
| 110 | Reception Unit |
| 115 | Input Unit |
| 120 | Storage Unit |
| 125 | Storage Unit |
| 130 | Processing Unit |
| 135 | Processing Unit |
| 140 | Output Unit |
| 145 | Display Unit |
| 150 | Transmission Path |
| 161 a | Communication Unit |
| 161 b | Communication Unit |
| 162 | Transmission Path |
| 164 | Transmission Path |
| 200 | Information Retrieval System |
| 210 | Information Retrieval System |
| 220 | Server |
| 230 | Terminal |
| 5100 | Server |
| 5110 | Internet Connection |
| 5300 | Information Terminal |
| 5400 | Information Terminal |
| 5450 | Housing |
| 5500 | Information Terminal |

1. An information retrieval system comprising:
a reception unit configured to receive a designated application;
a processing unit configured to perform processing using a database; and
an output unit configured to output information on the basis of a processing result of the processing unit,
wherein the database comprises at least data of specifications, drawings, and value information of a plurality of applications,
wherein the drawings comprise support drawings corresponding to scopes of claims,
wherein the processing unit calculates a first degree of similarity between a specification of the designated application and each of the specifications of the plurality of applications,
wherein the processing unit extracts a plurality of first similar applications from the plurality of applications on the basis of the first degree of similarity,
wherein the processing unit calculates a second degree of similarity between the support drawings of at least one of the plurality of first similar applications and at least one of drawings of the designated application, respectively,
wherein the processing unit extracts at least one similar drawing from the drawings of the designated application on the basis of the second degree of similarity, and
wherein for at least one of the plurality of first similar applications, the output unit outputs the value information, the support drawing, and the similar drawing.

2. The information retrieval system according to claim 1, wherein the output unit outputs the second degree of similarity between the support drawing of at least one of the plurality of first similar applications and the similar drawing.

3. An information retrieval system comprising:
a reception unit configured to receive a designated application;
a processing unit configured to perform processing using a database; and
an output unit configured to output information on the basis of a processing result of the processing unit,
wherein the database comprises at least data of specifications, drawings, and value information of a plurality of applications,
wherein the drawings comprise support drawings corresponding to scopes of claims,
wherein the processing unit calculates a first degree of similarity between a specification of the designated application and each of the specifications of the plurality of applications,
wherein the processing unit extracts a plurality of first similar applications from the plurality of applications on the basis of the first degree of similarity,
wherein the processing unit calculates a second degree of similarity between the support drawings of each of the plurality of first similar applications and at least one of drawings of the designated application, respectively,
wherein the processing unit extracts at least one second similar application by performing one or both of narrowing down and rearrangement of the plurality of first similar applications on the basis of the second degree of similarity,
wherein the processing unit extracts at least one similar drawing from the drawings of the designated application on the basis of the second degree of similarity, and
wherein for the second similar application, the output unit outputs the value information, the support drawing, and the similar drawing.

4. The information retrieval system according to claim 3, wherein the output unit outputs the second degree of similarity between the support drawing of the second similar application and the similar drawing.

5. The information retrieval system according to claim 1, wherein the value information comprises related product information.

6. The information retrieval system according to claim 1, further comprising:
a storage unit configured to store the processing result.

7. The information retrieval system according to claim 1,
wherein the designated application is an application pending in the Patent Office.

8. An information retrieval method comprising:
receiving a designated application;
calculating a first degree of similarity between a specification of the designated application and each of specifications of a plurality of applications;
extracting a plurality of first similar applications from the plurality of applications on the basis of the first degree of similarity;
calculating a second degree of similarity between a support drawing corresponding to a scope of claims of at least one of the plurality of first similar applications and at least one of drawings of the designated application, respectively;
extracting at least one similar drawing from the drawings of the designated application on the basis of the second degree of similarity; and
outputting value information, the support drawing, and the similar drawing for at least one of the plurality of first similar applications.

9. The information retrieval method according to claim 8,
wherein the second degree of similarity between the support drawing of at least one of the plurality of first similar applications and the similar drawing is output.

10. An information retrieval method comprising:
receiving a designated application;
calculating a first degree of similarity between a specification of the designated application and each of specifications of a plurality of applications;
extracting a plurality of first similar applications from the plurality of applications on the basis of the first degree of similarity;
calculating a second degree of similarity between a support drawing corresponding to a scope of claims of each of the plurality of first similar applications and at least oneof drawings of the designated application, respectively;
extracting at least one second similar application by performing one or both of narrowing down and rearrangement of the plurality of first similar applications on the basis of the second degree of similarity;
extracting at least one similar drawing the drawings of the designated application on the basis of the second degree of similarity; and
outputting value information, the support drawing, and the similar drawing for the second similar application.

11. The information retrieval method according to claim 10,
wherein the second degree of similarity between the support drawing of the second similar application and the similar drawing is output.

12. The information retrieval method according to claim 8,
wherein the value information comprises related product information.

13. The information retrieval method according to claim 8,
wherein the designated application is an application pending in the Patent Office.

14. The information retrieval system according to claim 3, wherein the value information comprises related product information.

15. The information retrieval system according to claim 3, further comprising: a storage unit configured to store the processing result.

16. The information retrieval system according to claim 3,
wherein the designated application is an application pending in the Patent Office.

17. The information retrieval method according to claim 10,
wherein the value information comprises related product information.

18. The information retrieval method according to claim 10,
wherein the designated application is an application pending in the Patent Office.
